(19) United States
(12) Patent Application Publication
(10) Pub. No.: US 2026/0031900 A1
(43) Pub. Date: Jan. 29, 2026

(54) ROUTING PACKETS BASED ON ENVIRONMENTAL CONDITIONS

(71) Applicant: International Business Machines Corporation, Armonk, NY (US)

(72) Inventors: Gandhi Sivakumar, Mountain View, CA (US); Kushal Sanjivkumar Patel, Pune (IN); Abhinauv Venugopal, Cerritos, CA (US); Sarvesh Sanjeev Patel, Pune (IN)

(21) Appl. No.: 18/781,778

(22) Filed: Jul. 23, 2024

(51) Int. Cl. H04B 7/185

(52) U.S. Cl. CPC H04B 7/18523; H04B 7/18519

(57) ABSTRACT

A computer-implemented method (CIM), according to one embodiment, includes performing a determination process for determining a satellite to transmit a first packet to a datacenter on Earth's surface, where the first packet originates on a parent satellite. The determination process includes determining a plurality of candidate satellites that each have a sufficient amount of processing resources for transmitting at least a predetermined amount of the first packet to the datacenter, where the candidate satellites include the parent satellite. The determination process further includes determining environmental conditions for the candidate satellites, and determining a first of the candidate satellites having environmental conditions associated with a first relatively lowest estimated energy expenditure during packet transmission. The CIM further includes causing the first candidate satellite to transmit at least a portion of the first packet to the datacenter.

### BACKGROUND

The present invention relates to the processing of packets of data, and more specifically, this invention relates to a determination process for determining a satellite to transmit a packet to a datacenter.

Communication networks typically include a plurality of communication devices that communicate with other communication devices via wireless signals. For example, communication devices may include, e.g., computers, cellular phones, fax machines, network enabled tablets, etc. These wireless signals are sometimes transmitted by being relayed via communication relay devices on Earth's surface, e.g., ground antennas, routers, modems, etc. In some cases, these wireless signals may additionally and/or alternatively be transmitted via connection requests that are output from communication devices to satellites and/or vice versa.

Cloud providers, e.g., such as corporations, establish relationships with satellite companies in some cases in order to enable the transmission of packets of data from satellites to datacenters on Earth's surface. For example, commercial satellite constellations may generate relatively extensive amounts of data that needs to be stored, processed, and analyzed.

### SUMMARY

A computer-implemented method (CIM), according to one embodiment, includes performing a determination process for determining a satellite to transmit a first packet to a datacenter on Earth's surface, where the first packet originates on a parent satellite. The determination process includes determining a plurality of candidate satellites that each have a sufficient amount of processing resources for transmitting at least a predetermined amount of the first packet to the datacenter, where the candidate satellites include the parent satellite. The determination process further includes determining environmental conditions for the candidate satellites, and determining a first of the candidate satellites having environmental conditions associated with a first relatively lowest estimated energy expenditure during packet transmission. The CIM further includes causing the first candidate satellite to transmit at least a portion of the first packet to the datacenter.

A computer program product (CPP), according to another embodiment, includes a set of one or more computer-readable storage media, and program instructions, collectively stored in the set of one or more storage media, for causing a processor set to perform the foregoing method.

A computer system (CS), according to another embodiment, includes a processor set, a set of one or more computer-readable storage media, and program instructions, collectively stored in the set of one or more storage media, for causing the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a flowchart of a method, in accordance with one embodiment of the present invention.

FIG. 2B is a flowchart of sub-operations of an operation of the flowchart of FIG. 2A, in accordance with one embodiment of the present invention.

FIG. 3 is a depiction of an atmospheric structure, in accordance with one embodiment of the present invention.

FIGS. 4A-4B are depictions of communication networks, in accordance with several embodiments of the present invention.

FIG. 5 is a depiction of communication network, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for determining a satellite to use for transmitting a packet of data based on predetermined environmental conditions.

In one general embodiment, a CIM includes performing a determination process for determining a satellite to transmit a first packet to a datacenter on Earth's surface, where the first packet originates on a parent satellite. The determination process includes determining a plurality of candidate satellites that each have a sufficient amount of processing resources for transmitting at least a predetermined amount of the first packet to the datacenter, where the candidate satellites include the parent satellite. The determination process further includes determining environmental conditions for the candidate satellites, and determining a first of the candidate satellites having environmental conditions associated with a first relatively lowest estimated energy expenditure during packet transmission. The CIM further includes causing the first candidate satellite to transmit at least a portion of the first packet to the datacenter.

In another general embodiment, a CPP includes a set of one or more computer-readable storage media, and program instructions, collectively stored in the set of one or more storage media, for causing a processor set to perform the foregoing method.

In another general embodiment, a CS includes a processor set, a set of one or more computer-readable storage media, and program instructions, collectively stored in the set of one or more storage media, for causing the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as satellite determination code of block 150 for determining a satellite to use for transmitting a packet of data based on predetermined environmental conditions. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

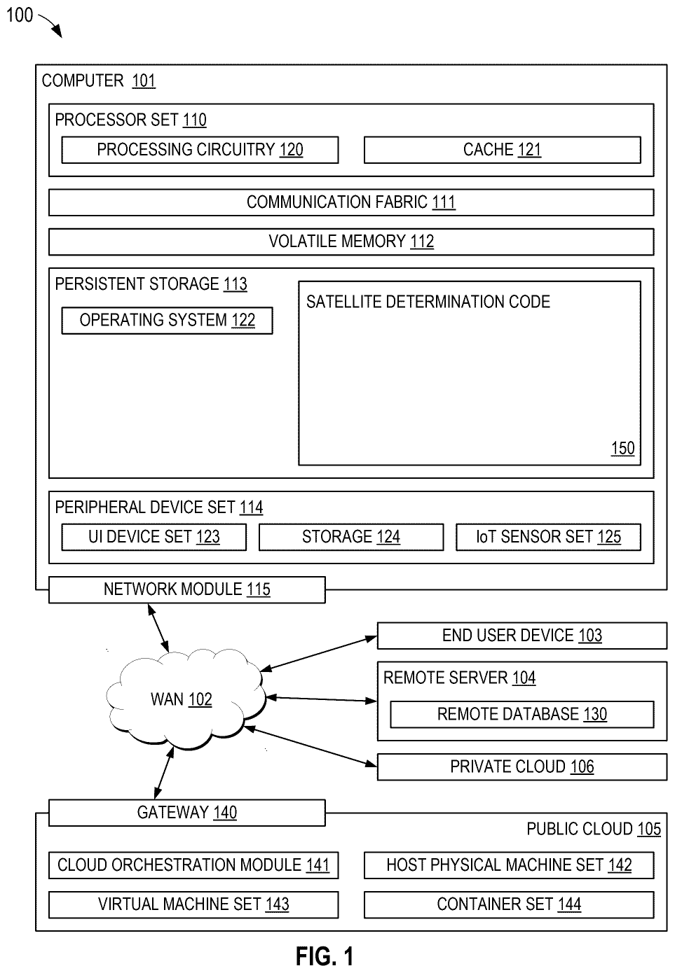

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, communication networks typically include a plurality of communication devices that communicate with other communication devices via wireless signals. For example, communication devices may include, e.g., computers, cellular phones, fax machines, network enabled tablets, etc. These wireless signals are sometimes transmitted by being relayed via communication relay devices on Earth's surface, e.g., ground antennas, routers, modems, etc. In some cases, these wireless signals may additionally and/or alternatively be transmitted via connection requests that are output from communication devices to satellites and/or vice versa.

Cloud providers, e.g., such as corporations, establish relationships with satellite companies in some cases in order to enable the transmission of packets of data from satellites to datacenters on Earth's surface. For example, commercial satellite constellations may generate relatively extensive amounts of data that needs to be stored, processed, and analyzed.

Satellites typically orbit the Earth in order to assist in the communication networks, such as those described above. The altitude at which a satellite orbits the Earth may depend on the type and components of a satellite. For example, a low Earth orbit (LEO) is, as the name suggests, an orbit that is relatively close to the Earth's surface. For example, these orbits are typically performed at an altitude of less than 1000 kilometers (km) but may be as low as 160 km above the Earth's surface. This is relatively low compared to the orbits of other satellites, but still relatively very far above the Earth's surface. Unlike satellites in geostationary orbit (GEO) that must always orbit along the Earth's equator, LEO satellites do not always follow a particular path around the Earth in the same way. Rather a plane of an orbit may be tilted with respect to the equator, and therefore there are relatively more available routes for satellites in LEO.

LEO satellites are revolving around the Earth at relatively lower altitudes than geo-stationary satellites, and hence LEO satellites are not stationary with respect to Earth's movement. Because the movement of LEO satellites can be observed from Earth's surface, and LEO satellites are relatively much closer to Earth's surface than geo-stationary satellites, to maintain the rotation equilibrium, the speed of LEO satellites is a metric which relatively largely impacts the footprint region when LEO satellites are used for direct connection purposes. This also means that a footprint coverage region of a LEO satellite is fairly limited in that coverage timelines are relatively shorter proportional to a speed that the LEO's are orbiting Earth's surface. For this reason, multiple LEO satellites may be orbiting the plane which acts as a mesh to offer continuous coverage for a given area. As will be described in greater detail elsewhere below, LEO satellites in such a mesh can be caused and/or configured to communicate with one another via inter-satellite links which serve as a relatively high speed network line between the satellites.

In approaches in which satellites directly serve user devices, there is no conventional process that determines and incorporates environmental conditions into a process of transmitting packets of data from the satellites to datacenters on Earth's surface. The devices within the datacenters that process the data and the satellites themselves are subject to heat based on their workload. Additionally, because there is limited power available in satellite datacenters, conventional techniques that fail to incorporate these environmental conditions into determinations of how to transmit a packet of data creates inefficiencies in communication networks, e.g., additional power consumption where other relatively more efficient transmission paths are available but remain unused. For example, datacenter assets like storage, switches, and servers, and satellite processing circuits used for transmitting packets of data are subject to heat dissipation, while significant energy is required to cool the components.

In sharp contrast to the deficiencies of conventional techniques described above for transmitting packets of data in communication networks, the techniques of embodiments and approaches described herein conserve power in the process of transmitting packets of data in communication networks from satellites to datacenters. More specifically, these techniques schedule packet transmission jobs (offload the packet transmission jobs) to satellites determined to have environmental conditions that are associated with relatively lower external temperatures. This reduces an overall energy consumption associated with fulfilment of the jobs. This also is important for both bringing sustainability into the satellite datacenters, and helping a scaling of work in communication networks that include satellites by effectively fulfilling transmission jobs while utilizing limited power.

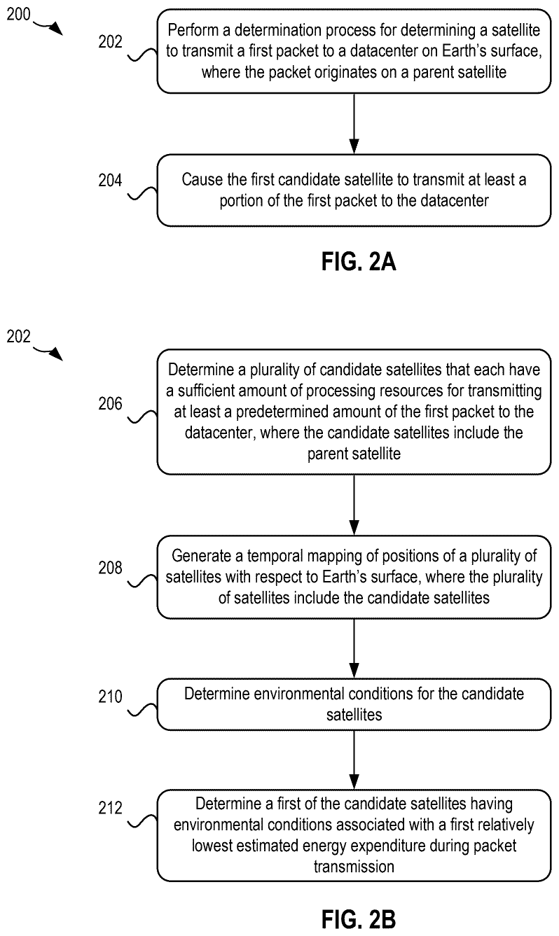

Now referring to FIG. 2A, a flowchart of a method 200 is shown according to one embodiment. The method 200 may be performed in accordance with aspects of the present invention in any of the environments depicted in FIGS. 1-5, among others, in various embodiments. Of course, more or fewer operations than those specifically described in FIG. 2A may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that, the operations of method 200 may be utilized for offloading a one or more packets of data from a parent satellite to a ground-based datacenter. Although various operations of embodiments and approaches described herein refer to a first data packet, the techniques described herein may additionally and/or alternatively be performed (concurrently or sequentially) with respect to a plurality of packets of data. Furthermore, although various operations are described herein to be performed with respect to datacenters on Earth's surface and satellite(s) orbiting the Earth, in some other approaches, the operations described herein may be performed with respect to any planet with datacenters thereon.

Operation 202 of method 200 includes performing a determination process for determining a satellite to transmit at least a portion of a first packet to a datacenter on Earth's surface. The type of data of the first packet may include, e.g., data that is generated by a satellite and intended to be backed up and/or stored by a datacenter, replication data, data that needs to be processed and/or analyzed and/or computed by a datacenter in place of a satellite, photos, audio recordings, etc. Furthermore, the first packet originates on a parent satellite, e.g., a satellite that generates the packet. Note that the satellite that is determined by the process and used to transmit at least a portion of the first packet to a datacenter on Earth's surface may end up being the parent satellite or another satellite. Illustrative techniques for performing the determination process are described below, e.g., see FIG. 2B.

Looking to FIG. 2B, exemplary sub-operations of performing a determination process for determining a satellite to transmit packet to a datacenter on Earth's surface are illustrated in accordance with one embodiment, one or more of which may be used to perform operation 202 of FIG. 2A. However, it should be noted that the sub-operations of FIG. 2B are illustrated in accordance with one embodiment which is in no way intended to limit the invention.

Sub-operation 206 includes determining a plurality of candidate satellites that each have a sufficient amount of processing resources for transmitting at least a predetermined amount of the first packet to the datacenter. The sufficient amount of processing resources for transmitting at least the predetermined amount of the first packet to the datacenter may, in some preferred approaches, be determined by the parent satellite, e.g., using data computation techniques that would become apparent to one of ordinary skill in the art after reading the descriptions herein.

As mentioned elsewhere above, the candidate satellites, in some approaches, include the parent satellite. Furthermore, the candidate satellites may additionally and/or alternatively include other satellites that are in communication with the parent satellite and/or within a predetermined range of the parent satellite within a predetermined amount of time (a range that allows for direct transfer of the packet from the parent satellite to the other satellite).

The candidate satellites are, in some approaches, determined based on results of a query that is issued, e.g., by the parent satellite, to all satellites that are within range and thereby able to receive the query. In some other approaches, the candidate satellites are determined from an existing and dynamically updated map, e.g., a mesh mapping of a plurality of satellites that include the satellites. In some other approaches, satellite information is obtained and used to generate a dynamically updated temporal mapping that details positions of the satellites, as will now be described below.

Satellite information associated with a plurality of satellites may be obtained. In some preferred approaches, at least one of the candidate satellites is a LEO satellite. At least one of the candidate satellites is a medium Earth orbit (MEO) satellite. In some other approaches, a majority of the satellites may be LEO and/or MEO satellites, all of the satellites may be LEO and/or MEO satellites, etc.

The satellite information may be obtained by a processing circuit that is located in the parent satellite and/or by a processing circuit that is in communication with at least one of the satellites. In such an approach, the processing circuit of the parent satellite may be configured to offload at least a portion of a packet for another satellite to transmit to a datacenter, accept at least a portion of a packet from other satellite(s), transmit a packet to a datacenter, relay satellite to other satellite(s), etc. Furthermore, in such an approach, the processing circuit may additionally and/or alternatively be configured to use the satellite information pertaining to other satellites to determine one or more metrics associated with the other satellites. In some other approaches, the satellite information may be obtained by a computer that is in communication with one or more of the satellites. The satellite information may, in some approaches, include, e.g., identifiers (IDs) of satellites, predetermined metrics associated with the satellites, software versions being run on the different satellites, etc. In some approaches the predetermined metrics associated with the satellites include, e.g., a current altitude of a satellite, a trajectory of a satellite, orbital plane information of a satellite, an average moving speed of a satellite, an orbital path of a satellite, a shape of a satellite's orbital path, etc.

The satellite information associated with the plurality of satellites may be obtained from data structures of the satellites. Upon instantiation, the data structures may be loaded to a service instance, and predefined data collection resources may be triggered to send data streams from an associated satellite to other satellites orbiting the Earth. For context, data streams may be sent between satellites (containing at least a portion of a packet), and from satellite(s) to datacenters, in some approaches. In some approaches, these transmissions may be performed as a part of application storage instances, e.g., such as where at least one of the satellites has obtained data that is to be transmitted to and stored by a target datacenter and/or storage device thereof for a client. In some approaches, datacenter locations may be identified and provisioned within the obtained satellite information. Communication with the application storage instances may be made and statuses may be enquired from the satellite information, e.g., ready to transmit data, not ready to transmit data, etc.

In some approaches, in order to establish communication paths between different satellites and/or between satellites and datacenters on Earth's surface, resource capitals may be provisioned for a service using insertions to a softwarization management plane and virtual network functions may be triggered to start the data transmission over an established transmission line. Infrastructure application programming interface (API) instances of the satellites may, in some approaches, be initiated, and handshaking may be prepared in such an exchange of satellite information, where the handshakes thereafter may be used to transmit packets between satellites, e.g., in the event that a candidate satellite other than the parent satellite is determined for transmitting the packet to a datacenter.

Satellite infrastructure APIs are, in some approaches, invoked to obtain the satellite information. For example, in some approaches in which the satellite information includes physical parameters, e.g., a current altitude, a footprint region, a trajectory, orbital plane information, an average moving speed of eNodeBs of a satellite, etc., sub-operation 206 may include invoking satellite infrastructure APIs.

In some approaches, only a subset of the satellites associated with the obtained satellite information are predetermined to be allowed to and/or capable of transmitting packet to datacenter(s) in accordance with method 200. As briefly noted elsewhere above, in some approaches, this subset of satellites may include satellites determined to have a sufficient amount of processing resources for transmitting at least the predetermined amount of the first packet to the datacenter. In some other approaches, only a subset of the satellites orbiting earth are to be considered in method 200 for processing jobs. Accordingly, information from all satellites in a predetermined mesh, e.g., a predetermined LEO satellite mesh, which are predetermined to be capable of processing packet transmission requests are enquired during the obtaining of the satellite information.

In some approaches, the information includes satellite universally unique identifiers (UUIDs), software eNodeB IDs and/or other static metadata that can be derived from configurable parsing approaches that would become apparent to one of ordinary skill in the art after reading the descriptions herein. In some approaches, orbital characteristic locational identifiers and/or other motion dynamic information may be loaded during this process of identifying candidate satellites. The location identifiers of the satellites are, in some approaches, mapped with associated earth centric geo-locations and saved into metadata mappers.

Subsequent to obtaining information from a plurality of satellites that are capable transmitting at least a portion of a packet to a datacenter, the obtained information may be used to determine movement of the satellites with respect to Earth. For example, the obtained satellite information may be used to determine a trajectory of the individual satellites. In some approaches, the trajectory of a given satellite may be determined, e.g., based on tracked historical orbital information associated with the satellite, based on a current tracking of the satellite, from a table of predetermined metrics in the obtained satellite information, etc. The determined trajectory of a given one of the satellites may then be mapped against a geo-location of the target datacenter. This information may, in some approaches, be saved into a metadata mapper of objects which may be used to calculate an exact positional reference of the given satellite in a predetermined plane of satellites that includes at least the given satellite. A check may additionally and/or alternatively be performed, in some approaches, to determine connection processing requirements in a coverage footprint of the satellites. Method 200 additionally and/or alternatively includes collecting additional information and/or using the collected satellite information for calculating a speed, direction, and trajectory regions of the satellites.

An optional sub-operation of operation 202, in some approaches, includes determining footprint coverage region(s) of one or more of the candidate satellites. For context, the footprint coverage region of a satellite is an area of Earth below the orbiting satellite that the satellite is within range of connecting to one or more target devices located on the area of Earth, e.g., such as datacenters located within the area of Earth. The area of Earth below the orbiting satellite that makes up the footprint coverage region of the satellite may depend on communication hardware of the satellite. For example, in some approaches, a LEO satellite may have a relatively larger footprint coverage region than a footprint coverage region of a MEO satellite as a result of the MEO satellite having relatively more outdated communication hardware than the LEO satellite, e.g., signal broadcasting hardware of a processing circuit. The footprint coverage region of a satellite may be determined based on metrics associated with the satellite, e.g., metrics from the obtained satellite information. For example, a footprint coverage region of a first satellite may be determined based on metrics associated with the first satellite, e.g., a current altitude, a trajectory, orbital plane information and an average moving speed. Techniques for determining a connectivity and/or communication range of a candidate satellite, based on metrics associated with the candidate satellite, that would become apparent to one of ordinary skill in the art after reading the descriptions herein may be used. The footprint coverage region of a given candidate satellite is used to determine candidate packet transmission jobs for the satellite to fulfill, e.g., in response to a determination that the footprint coverage region of the satellite is within range of a datacenter that that a packet is to be transmitted to.

In some preferred approaches, each of the candidate satellites are determined to have a footprint coverage region that is not within a predetermined proximity to a predetermined bodies of water, e.g., oceans, during a transmission timeline of the first packet. For context, as a footprint coverage region of a candidate satellite passes over predetermined bodies of water such as oceans, the candidate satellite may be unable to connect to datacenters located on Earth's land surfaces. Accordingly, in order to preserve at least some processing resources that would otherwise be expended on consideration of candidate satellites that are out of connectivity range of datacenters, candidate satellites determined to have a footprint coverage region that is within the predetermined proximity to the predetermined bodies of water may be excluded, e.g., filtered, from consideration for transmitting the first packet.

Sub-operation 208 includes generating a temporal mapping of positions of a plurality of satellites with respect to Earth's surface. In some preferred approaches, the plurality of satellites include the candidate satellites, and the temporal mapping is generated and maintained using satellite information. In some approaches, the temporal mapping of the satellites is generated by appending the footprint coverage regions of the satellites with Earth's surface on a predetermined type of map, e.g., on a graphical user interface-based map to indicate the footprint coverage regions of the satellites as the satellites traverse with respect to Earth's surface. In some approaches, this appending may be performed by injecting a ground surface coordinate map with satellite geographical location information and altitudes of the respective satellites.

The candidate satellites are, in some approaches, determined from the temporal mapping. For example, in some approaches, a plurality of candidate satellites are identified as satellites, from the plurality of satellites in the generated temporal mapping, that have footprint coverage regions within a predetermined distance from the datacenter within a predetermined time period, e.g., a time period specified within a service level agreement that the first packet must be transmitted to the datacenter by.

The determination process, in some approaches, includes determining environmental conditions for the candidate satellites, e.g., see sub-operation 210. For context, the environmental conditions are preferably environmental conditions that have a potential for changing performance of the associated satellites as the environmental conditions change. For example, in one preferred approach, for a first of the candidate satellites, a first of the environmental condition includes an average air temperature of a current location of the candidate satellite. Relatively high predetermined air temperature ranges may cause processing circuits of a satellite to use relatively more power than the processing circuit otherwise would in relatively moderate and/or relatively lower predetermined air temperature ranges. These air temperature ranges may vary depending on one or more factors at any given time. These factors may include, e.g., variation in temperature that occur from the highs of the day to the cool of nights (which may depend on the constantly changing location of the sun with respect to Earth and the satellite) and is also known as “diurnal temperature variation”. These temperature factors may additionally and/or alternatively be based on periods of a month, or a year, etc. Temperature also varies greatly at different altitudes of the satellites with respect to Earth's surface and this variation in temperature characterizes the four layers that exist in the atmosphere which include the troposphere, stratosphere, mesosphere, and thermosphere. Accordingly, the different candidate satellites may be grouped according to one or more of these factors to determine these temperatures and/or to determine the satellite to use for transmitting the first packet.

Another environmental condition may, in some approaches, include an average humidity of a current location of the candidate satellite. In some approaches, a humidity sensor may be used to determine an average air temperature of a given satellite or vice versa. A predetermined relational formula between humidity and temperature of a type that would become apparent to one of ordinary skill in the art after reading the descriptions herein may be used, e.g., to cross reference sensor readings, in response to a determination that one of the sensors is non-operational, etc. In such a formula, in some approaches, temperature and humidity may be inversely proportional, e.g., a temperature increases leads to a decrease in relative humidity and vice versa.

In yet some other approaches, another environmental condition may, in some approaches, include an internal temperature of the candidate satellite. For context, in some approaches, the internal temperature of a satellite may be based on heat dissipation experienced as a result of operation of the internal components of the satellite, e.g., such as discharging of a battery to power a processing circuit, etc.

Although various approaches described herein detail determinations of environmental conditions associated with the candidate satellites, in some approaches, the operations and environmental conditions described herein may additionally and/or alternatively be performed with respect to ground-level environmental conditions of the datacenter, e.g., atmospheric temperature ranges of the datacenter which may depend on several factors, such as: average air temperature, average humidity, a regime of winds (intensity, duration, variation, temperature, etc.), a proximity to large bodies of water (such as oceans), etc.

The environmental conditions may be used to determine a first of the candidate satellites having environmental conditions associated with a first relatively lowest estimated energy expenditure during packet transmission, e.g., see sub-operation 212. In some approaches, a number of conditions may contribute to the estimated energy expenditure of a given one of the candidate satellites during packet transmission. Accordingly, in some approaches, in order to determine the first satellite candidate, the determination process may additionally and/or alternatively include calculating the estimated energy expenditures for the candidate satellites. In some approaches, one or more of the estimated energy expenditures may be based on a task load of the associated candidate satellite during a transmission timeline of the first packet. In other words, in one or more of such approaches, candidate satellites using a relatively greater percentage of their processing potential may be estimated to have relatively grater estimated energy expenditures than other candidate satellites using a relatively lesser percentage of their processing potential (which may thereby be estimated to have relatively lesser estimated energy expenditures). One or more of the estimated energy expenditures may additionally and/or alternatively be based on the environmental condition(s). In some approaches, a predetermined upper temperature threshold may be applied that, when exceeded, disqualifies the associated candidate satellite from being used for transmitting a packet of data and/or a predetermined lower temperature threshold may be applied that, when not exceeded (temperatures are less than the predetermined lower temperature), disqualifies the associated candidate satellite from being used for transmitting a packet of data. Similar thresholds may be applied to the other types of environmental conditions.

Candidate satellites having environmental conditions that do not fall outside of the upper and lower thresholds mentioned above may be used for determining the first candidate satellite, in some approaches. These satellites may, in some approaches, be ranked according to the different environmental factors, which may each have a dynamically adjusted weightage applied to the factors for the rankings. For each environmental condition the associated ranking may have a preferred ranking condition. For example, for the environmental condition average air temperature, for the candidate satellites having environmental conditions that do not fall outside of the upper and lower thresholds mentioned above, candidate satellites having relatively lower average air temperatures may be ranked relatively higher than candidate satellites having relatively higher average air temperatures. In other words, environmental conditions associated with relatively lower estimated energy expenditures (i.e., relatively lower average air temperatures rather than relatively higher air temperatures in the example above) during packet transmission are ranked relatively higher, e.g., higher priorities, than environmental conditions associated with relatively greater estimated energy expenditures.

In some approaches, the first candidate satellite is determined, e.g., selected, for using to transmit at least a portion of the first packet to the datacenter. In one or more of such approaches, the first candidate satellite is determined based on having a relatively highest ranking, which in some approaches, may be rating that considers a plurality of different environmental condition rankings. For example, in some approaches, the first candidate satellite is determined based on average rankings. In some other approaches, each of the different rankings may be assigned a different weight (importance factor) such that determination of the first candidate satellite considers the different weights.

Operation 204 includes causing the first candidate satellite to transmit at least a portion of the first packet to the datacenter. In some approaches, in order to cause the first candidate satellite to transmit at least the portion of the first packet to the datacenter, work associated with the first packet is offloaded to the first candidate satellite and/or target application and/or service instances. In cases in which the first candidate satellite is not the parent satellite, the parent satellite may wait until a determination that execution of transmission of the first packet is completed to update status associated with the first packet. Furthermore, in the process of transmitting the first packet to the datacenter, the first candidate satellite may send an outcome of transmitting the job to a caller of the first packet, and in response to a determination that the transmission is complete, the parent satellite, the first candidate satellite and/or the datacenter may mark the process as being completed.

The first candidate satellite is, in some approaches, not the parent satellite. Accordingly, in one or more of such approaches, causing the first candidate satellite to transmit at least a portion of the first packet to the datacenter may include instructing the parent satellite to output an offload request to the first candidate satellite. In other words, in some approaches, a hop may be performed between two or more of the candidate satellites in order to enable the transmission of the first packet to the datacenter. These one or more hops may, in some approaches, be performed between the same types of satellites that are within the same altitude region of the atmosphere, e.g., all orbiting Earth within the stratosphere. In some other approaches, at least some of the satellites used to transmit the first packet to the datacenter may be different types of satellites and/or in different altitude regions of the atmosphere. For example, in one approach, the first candidate satellite is a LEO satellite, and the second candidate satellite is a MEO satellite. In other words, a hop may be performed between the LEO and MEO candidate satellites before the packet is transmitted to Earth provided that the total transmission energy expenditure is less than the parent satellite transmitting the packet (e.g., the hopped portion) to the datacenter.

In some approaches, the first candidate satellite only has processing resources for transmitting a first portion of the first packet to the datacenter. In some approaches in which the first candidate satellite is not the parent satellite, this condition is preferably determined before the first candidate satellite is transferred more than first portion of the first packet. The first candidate satellite may be caused to transmit the first portion of the first packet to the datacenter and at least one other candidate satellite may be determined from the determination process for transmitting a remainder portion of the first packet. For example, in some approaches, the determination process may additionally and/or alternatively include determining a second of the candidate satellites having environmental conditions associated with a second relatively lowest estimated energy expenditure during packet transmission. The second candidate satellite may be caused to transmit a second portion of the first packet to the datacenter.

With the enablement of these LEO satellite datacenters and the mechanisms to send and receive packets from satellites directly via the communication networks, the techniques described herein offer performance benefits to the applications and devices accessing data of the packet. In some approaches, this is because these devices are directly connected to satellite processing locations, and therefore the transmission latency is relatively very low due to omitted interference of intermediate network components. Furthermore, LEOs orbit relatively close to earther surface (compared to other types of satellites), and therefore can be used for communication purposes where the device (mobile or IoT devices) on Earth can connect directly to the LEO satellites for making data exchange (instead of earth based eNodeBs). In order to efficiently free up processing potential on these satellites for these communication purposes, the techniques described herein may be used to transmit packets of data for processing at datacenters rather than the satellites themselves having to perform such processing.

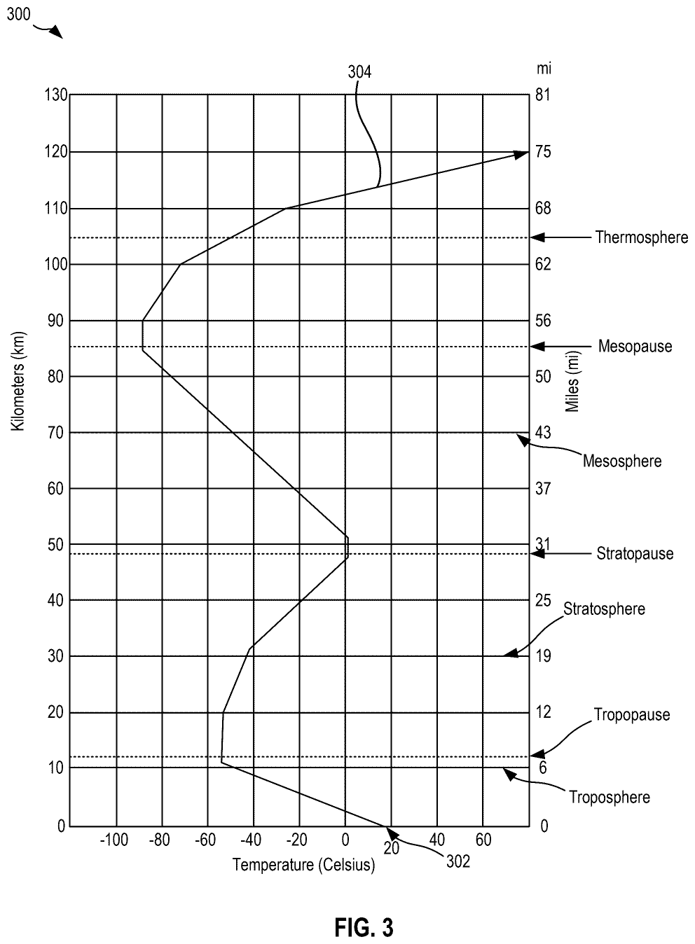

FIG. 3 depicts an atmospheric structure 300, in accordance with one embodiment. As an option, the present atmospheric structure 300 may be implemented in conjunction with features from any other embodiment listed herein, such as those described with reference to the other FIGS. Of course, however, such atmospheric structure 300 and others presented herein may be used in various applications and/or in permutations which may or may not be specifically described in the illustrative embodiments listed herein. Further, the atmospheric structure 300 presented herein may be used in any desired environment.

For context, the atmospheric structure 300 illustrates different portions of Earth's atmosphere. Beginning at Earth's surface 302, the atmospheric structure 300 includes a plurality of atmospheric levels, e.g., the see a troposphere, a tropopause, a stratosphere, etc. Temperature 304 varies greatly at different heights relative to Earth's surface 302 and this variation in temperature characterizes the four layers that exist in the atmosphere. These layers include the troposphere, stratosphere, mesosphere, and thermosphere.

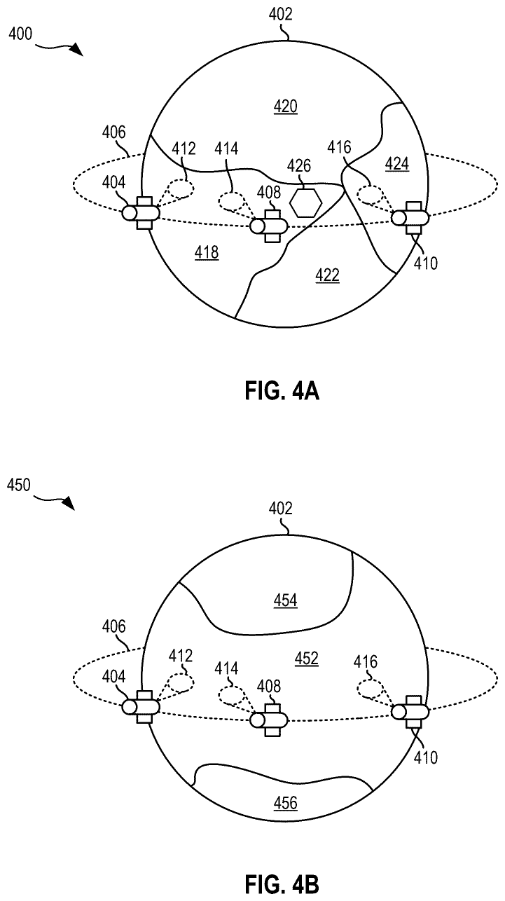

FIGS. 4A-4B depict communication networks 400 and 450, in accordance with various embodiments. As an option, the present communication networks 400 and 450 may be implemented in conjunction with features from any other embodiment listed herein, such as those described with reference to the other FIGS. Of course, however, such communication networks 400 and 450 and others presented herein may be used in various applications and/or in permutations which may or may not be specifically described in the illustrative embodiments listed herein. Further, the communication networks 400 and 450 presented herein may be used in any desired environment.

Referring first to FIG. 4A, communication network 400 is located around the planet Earth 402. A first candidate satellite 404, a second candidate satellite 408 and a third candidate satellite 410 orbit the Earth along an orbital path 406. A footprint coverage region 412 of the first candidate satellite 404 changes as the first candidate satellite 404 orbits the Earth along the orbital path 406. Similarly, the second candidate satellite 408 has a footprint coverage region 414 and the third candidate satellite 410 has a footprint coverage region 416. For context, a first land mass 418, a first body of water 420, a second body of water 422 and a second land mass 424 of the Earth are also shown in FIG. 4A.

A core idea of techniques described herein is to provide operations that work with satellite-based datacenters. These operations include collecting information about infrastructure management services about motion dynamics, and collecting activation timelines for the datacenter components, among other satellite information, in some approaches. Based on the collected information at least one candidate satellite may be selected for offloading data processing, e.g., such as in cases in which a relatively higher workload is present. These operations may be used to minimize energy requirements of offloading a packet of data to a datacenter. In some approaches, techniques described herein may be used to determine a satellite in a LEO mesh that is located in an atmospheric region that has a coolest outside temperature. In one or more of such approaches, the selected candidate satellite may be scheduled to perform the heavy-duty jobs on a schedule LEO processor so that heat can be dissipated without external energy consumption.

In some approaches, a process running a LEO satellite datacenter manager service may be automatically initiated and collect information about hardware and software components for maintenance activities that are to be performed. These components and/or the collected information may, in some approaches, include storage appliances, application instances and internal system components such as processor capabilities, devices RAM, cache, and/or NAND flash solid state drives in datacenters. The service may be further configured to collect the information from various LEO infrastructure resources in order to determine the motion dynamic of candidate satellites. This, in some approaches, includes orbital characteristics, <Hmin, Hmax> tuple details and motion information including the direction vectors, speed and rotation information which the saved into the metadata mapper classes for further information extraction. From collected motion dynamics, footprint coverage regions of the candidate satellites may be determined to understand which geographical locations 426 are covered by footprint coverage regions at a given point in time when relatively greater workloads are expected. This may, in some approaches, be further used to determine proactive offload arrangements, which may help to understand the timeline windows for activity events based on application activity and a determined nature of serving regions.

Information about the candidate satellites, e.g., about location, orbital characteristics, speed, etc., may be enquired from all the satellites in a candidate satellite mesh. In some approaches, this information is exchanged between the candidate satellites to understand a nature of orbit and atmospheric characteristics for the satellites. Additionally, in some approaches, temperature statistics collected by infrastructure APIs of the satellites may be maintained per timelines that are shared across the mesh (in order to enable predictive measures to be made to ensure that jobs including packet transmission are scheduled on a correct satellite). Once the information exchange is completed, the satellite information may be saved to one or more of the candidate satellites (saves into a local metadata store which is thereafter enquired in response to a determination that a job offload request is received).

In response to a determination that a job offload request (to transmit a packet to a datacenter) is received, a first level of enquiry may be performed for required technological constraints such as hardware and software availability within remote candidate satellites in the mesh. This enquiry is performed in order to determine a list of candidate satellites that are capable of serving the request (based on a current hardware and software of the candidate satellites). Once a list of candidate satellites is ready, in some approaches, a local metadata store is performed to obtain expected external temperatures of the candidate satellites, e.g., which may be determined based on orbital characteristics of the candidate satellites. A satellite determined to have a relatively lowest external temperature is expected to send the job request. In some approaches, a determination may be made that all the candidate satellites are sending job requests to a single target which has a relatively lowest temperature. Accordingly, a transmission of a given packet may, in some approaches, be distributed to a plurality of candidate satellites. For example, threshold-based policies may be applied that are configured to cause the rejection of a request in response to a determination that overall performance of a candidate satellite will decrease as a result of performing a transmission of a packet. In such cases, in response to a determination that a target candidate satellite is experiencing overloading, an offload request is preferably caused to be rejected, and a parent satellite may be caused to iterate via other candidate satellites in the mesh metadata repository to locate “next best” candidate satellite for performing the transmission of the packet.

Based on packet transmission jobs being offloaded to candidate satellites determined to have a relatively lowest outside temperature, an overall cooling power requirement to process the job (perform the packet transmission to a datacenter) is reduced. This preserved power is thereby available for accommodating other jobs and scaling the LEO work. This will not only make sustainable satellite-based datacenters, but also help promote cooling based on relatively less energy being used by equipment in the infrastructure of the communication network 400.

Referring now to FIG. 4B, the communication network 450 illustrates a different portion of Earth's surface that the candidate satellites pass over. For example, the footprint coverage regions of the satellites are shown passing over an ocean 452 and different bodies of land 454 and 456.

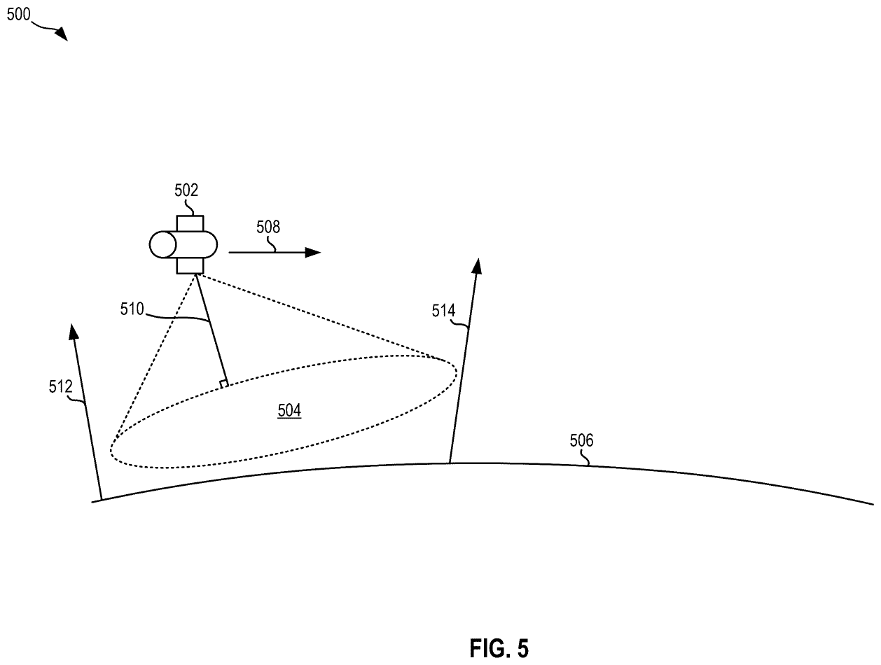

FIG. 5 depicts a communication network 500, in accordance with one embodiment. As an option, the present communication network 500 may be implemented in conjunction with features from any other embodiment listed herein, such as those described with reference to the other FIGS. Of course, however, such communication network 500 and others presented herein may be used in various applications and/or in permutations which may or may not be specifically described in the illustrative embodiments listed herein. Further, the communication network 500 presented herein may be used in any desired environment.

The communication network 500 includes a parent satellite 502 that has a footprint coverage region 504 that traverses over Earth's surface 506 as the parent satellite orbits Earth. Satellite information associated with a plurality of satellites may be determined and/or obtained in order to determine a temporal mapping of the satellites. For example, such information may detail that the parent satellite is traveling in a first direction 508 over Earth's surface 506 and/or a current altitude 510 of the parent satellite with respect to an inference of the footprint coverage region. The temporal mapping may be used to determine at what time the footprint coverage region will no longer be within a predetermined proximity to a first portion of land, e.g., see first island boundary 512, and within a predetermined proximity to a second portion of land, e.g., see second island boundary 514. In some approaches, the information is collected by a satellite datacenter manager service, and the collected information details hardware and software components of the satellites. This information may additionally and/or alternatively include a list of devices and/or components or software sub-components that are due for maintenance activities. The information may additionally and/or alternatively detail information about storage appliance, application instances and internal system components such as device RAM, cache, or NAND flash solid state drives in the datacenters, etc. In some approaches, an interface may be used to collect the information and/or locate the components based on priorities and interrupt masking capacity.

Collected motion dynamics within the obtained satellite information may be used to determine footprint coverage regions of the satellites. For context, these determinations are performed in order to understand the geographical locations points that are covered by the satellites at a given point in time.

In some approaches, a temporal mapping of positions of the satellites with respect to Earth's surface is generated. Thereafter, in response to receiving a request for an offload of a packet of data to a datacenter, a first level of enquiry may be performed to determine whether any of the satellites have technological constraints, e.g., hardware and/or software, that would not allow one or more of the satellites in the mesh to transmit the packet to the datacenter. This serves as a first level of selection and may be used to generate a list candidate satellites, e.g., a list of the satellites that are capable of serving the request based on a current set of hardware and software stats of the candidate satellites.

Once the list of candidate satellites is prepared, in some approaches, a local metadata store may be performed to obtain expected external temperatures of the candidate satellites (based on the orbital characteristics of the candidate satellites). The candidate satellite determined to have a relatively lowest expected external temperature may be determined and used to transmit the packet to the datacenter. In some approaches, more than one of the candidate satellites may be determined to have the same relatively low temperature. Accordingly, in some approaches, multiple candidate satellites may be used to transmit the packet to the datacenter. Predetermined threshold-based policies may, in some approaches, be activated which include rules that cause a rejection of the request by satellites that would otherwise impact an overall performance of a communication network by performing the transmission. In response to a determination that one of the satellites that is selected for transmitting the packet is experiencing overloading, another of the candidate satellites may be selected for performing the transmission. This redirect may include the request being caused to be rejected and the parent satellite being caused to iterate via other candidate satellites in the mesh metadata repository to locate a “next best” candidate for performing the transmission.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method (CIM), the CIM comprising:
performing a determination process for determining a satellite to transmit a first packet to a datacenter on Earth's surface, wherein the first packet originates on a parent satellite, wherein the determination process includes:
determining a plurality of candidate satellites that each have a sufficient amount of processing resources for transmitting at least a predetermined amount of the first packet to the datacenter, wherein the candidate satellites include the parent satellite,
determining environmental conditions for the candidate satellites, and
determining a first of the candidate satellites having environmental conditions associated with a first relatively lowest estimated energy expenditure during packet transmission; and
causing the first candidate satellite to transmit at least a portion of the first packet to the datacenter.

2. The CIM of claim 1, wherein the candidate satellites are low Earth orbit (LEO) satellites or medium Earth orbit (MEO) satellites.

3. The CIM of claim 1, wherein the environmental conditions are selected from the group consisting of: average air temperature of a current location of the candidate satellite, an average humidity of a current location of the candidate satellite, and internal temperature of the candidate satellite.

4. The CIM of claim 1, wherein the first candidate satellite only has processing resources for transmitting a first portion of the first packet to the datacenter, wherein the first candidate satellite is caused to transmit the first portion of the first packet to the datacenter, wherein the determination process includes: determining a second of the candidate satellites having environmental conditions associated with a second relatively lowest estimated energy expenditure during packet transmission, and the CIM comprising: causing the second candidate satellite to transmit a second portion of the first packet to the datacenter.

5. The CIM of claim 4, wherein the first candidate satellite is a low Earth orbit (LEO) satellite, wherein the second candidate satellite is a medium Earth orbit (MEO) satellite.

6. The CIM of claim 1, the CIM comprising: generating a temporal mapping of positions of a plurality of satellites with respect to Earth's surface, wherein the plurality of satellites include the candidate satellites, wherein the candidate satellites are determined from the temporal mapping.

7. The CIM of claim 1, wherein each of the candidate satellites are determined to have a footprint coverage region that is not within a predetermined proximity to a predetermined bodies of water during a transmission timeline of the first packet.

8. The CIM of claim 1, wherein the first candidate satellite is not the parent satellite, wherein causing the first candidate satellite to transmit at least a portion of the first packet to the datacenter includes instructing the parent satellite to output an offload request to the first candidate satellite.

9. The CIM of claim 1, wherein the determination process includes: calculating the estimated energy expenditures for the candidate satellites, wherein each of estimated energy expenditures is based on: a task load of the associated candidate satellite during a transmission timeline of the first packet and environmental conditions for associated candidate satellite.

10. A computer program product (CPP), the CPP comprising:
a set of one or more computer-readable storage media; and
program instructions, collectively stored in the set of one or more storage media, for causing a processor set to perform the following computer operations:
perform a determination process for determining a satellite to transmit a first packet to a datacenter on Earth's surface, wherein the first packet originates on a parent satellite, wherein the determination process includes:
determining a plurality of candidate satellites that each have a sufficient amount of processing resources for transmitting at least a predetermined amount of the first packet to the datacenter, wherein the candidate satellites include the parent satellite,
determining environmental conditions for the candidate satellites, and
determining a first of the candidate satellites having environmental conditions associated with a first relatively lowest estimated energy expenditure during packet transmission; and
cause the first candidate satellite to transmit at least a portion of the first packet to the datacenter.

11. The CPP of claim 10, wherein the candidate satellites are low Earth orbit (LEO) satellites or medium Earth orbit (MEO) satellites.

12. The CPP of claim 10, wherein the environmental conditions are selected from the group consisting of: average air temperature of a current location of the candidate satellite, an average humidity of a current location of the candidate satellite, and internal temperature of the candidate satellite.

13. The CPP of claim 10, wherein the first candidate satellite only has processing resources for transmitting a first portion of the first packet to the datacenter, wherein the first candidate satellite is caused to transmit the first portion of the first packet to the datacenter, wherein the determination process includes: determining a second of the candidate satellites having environmental conditions associated with a second relatively lowest estimated energy expenditure during packet transmission, and the CIM comprising: causing the second candidate satellite to transmit a second portion of the first packet to the datacenter.

14. The CPP of claim 13, wherein the first candidate satellite is a low Earth orbit (LEO) satellite, wherein the second candidate satellite is a medium Earth orbit (MEO) satellite.

15. The CPP of claim 10, the CPP comprising: program instructions, collectively stored in the set of one or more storage media, for causing the processor set to perform the following computer operations: generate a temporal mapping of positions of a plurality of satellites with respect to Earth's surface, wherein the plurality of satellites include the candidate satellites, wherein the candidate satellites are determined from the temporal mapping.

16. The CPP of claim 10, wherein each of the candidate satellites are determined to have a footprint coverage region that is not within a predetermined proximity to a predetermined bodies of water during a transmission timeline of the first packet.

17. The CPP of claim 10, wherein the first candidate satellite is not the parent satellite, wherein causing the first candidate satellite to transmit at least a portion of the first packet to the datacenter includes instructing the parent satellite to output an offload request to the first candidate satellite.

18. The CPP of claim 10, wherein the determination process includes: calculating the estimated energy expenditures for the candidate satellites, wherein each of estimated energy expenditures is based on: a task load of the associated candidate satellite during a transmission timeline of the first packet and environmental conditions for associated candidate satellite.

19. A computer system (CS), the CS comprising:
a processor set;
a set of one or more computer-readable storage media; and
program instructions, collectively stored in the set of one or more storage media, for causing the processor set to perform the following computer operations:
perform a determination process for determining a satellite to transmit a first packet to a datacenter on Earth's surface, wherein the first packet originates on a parent satellite, wherein the determination process includes:
determining a plurality of candidate satellites that each have a sufficient amount of processing resources for transmitting at least a predetermined amount of the first packet to the datacenter, wherein the candidate satellites include the parent satellite,
determining environmental conditions for the candidate satellites, and
determining a first of the candidate satellites having environmental conditions associated with a first relatively lowest estimated energy expenditure during packet transmission; and
cause the first candidate satellite to transmit at least a portion of the first packet to the datacenter.

20. The CS of claim 19, wherein the candidate satellites are low Earth orbit (LEO) satellites or medium Earth orbit (MEO) satellites.
